(19) United States
(12) Patent Application Publication
(10) Pub. No.: US 2004/0148604 A1
(43) Pub. Date: Jul. 29, 2004

(54) Method of and system for assessing progress of a task

(76) Inventors: Elisabeth Francisca Maria Steffens, Eindhoven (NL); Reinder Jaap Bril, Eindhoven (NL)

Correspondence Address: U S Philips Corporation, Intellectual Property Department, PO Box 3001, Briarcliff Manor, NY, 10510, US

(21) Appl. No.: 10/479,359

(22) PCT Filed: Jun. 3, 2002
(86) PCT No.: PCT/IB02/02012

(30) Foreign Application Priority Data
Jun. 5, 2001 (EP) 01202128.3

(51) Int. Cl. G06F 9/46

(52) U.S. Cl. 718/100

(57) ABSTRACT

Within the real-time processing domain, processing for example a video frame or audio can be divided into a number of tasks. Tasks receive budget (S102) for the resources it is allowed to use during processing. Since the processing performed by the tasks have timing constraints, a task must be able to determine its progress (S108). To enable a task to determine its progress the task refers to an amount of reference clock cycles it uses from a virtual reference clock and compares this amount to the number of sub-processing steps the task has performed. The virtual reference clock provides a plurality of reference clock cycles, wherein a reference clock cycle of the plurality of reference clock cycles is proportional to a ratio between the plurality of real-time clock cycles and the number of clock cycles comprised within the real-time budget.

The invention relates to a method of assessing progress of a task, the task executing on a real-time processor, the real-time processor providing a plurality of real-time clock cycles and the method comprising the following steps:

a first step of reserving a real-time budget for the task, wherein the real-time budget comprises a number of clock cycles that is equal to at least a part of the plurality of real-time clock cycles;

a second step of assessing the progress of the task by administrating a real amount of the plurality of real-time clock cycles used by the task.

Furthermore the invention relates to a system for assessing progress of a task, the system comprising:

real-time processor means conceived to provide a plurality of real-time clock cycles;

reserving means conceived to reserve a real-time budget for the task, wherein the real-time budget comprises a number of clock cycles that is equal to at least a part of the plurality of real-time clock cycles;

administration means conceived to administrate a real amount of the plurality of real-time clock cycles used by the task.

An embodiment of the method and the system of the kind set forth above is known from EP-B-0 534 884. Here, a multi-task computer system is disclosed that must provide task execution within a hard real-time environment like multi-media computers and display systems. Within this computer system, each task must declare its own maximum execution cycle count limit that is required by the task to run to completion and the computer system provides cycle count registers to count the processor cycles used by each individual task. Furthermore, the computer system keeps track of, amongst others, cycles remaining per individual task in case the task has been preempted by a higher priority task and prevents any individual task from exceeding its declared and specified maximum execution cycle count during the execution of the task. A measure of the system processor usage can be calculated by keeping track of the used cycles for each task. In order for a task to interpret how many processor cycles it has left at a given time, the task must inquire the system for the number of cycles it can still use and the task must implement special logic for interpretation.

It is an object of the invention to provide a method according to the preamble that assesses the progress of a task in an improved way. To achieve this object, the method according to the invention is characterized in that

the task further refers to a virtual reference clock, the virtual reference clock providing a plurality of reference clock cycles, wherein a reference clock cycle of the plurality of reference clock cycles is proportional to a ratio between the plurality of real-time clock cycles and the number of clock cycles comprised within the real-time budget; and the method further comprises:

a third step of proceeding the virtual clock at least one reference clock cycle when real-time budget is provided to the task; and

wherein the second step of the method further comprises administrating a reference amount of the plurality of reference clock cycles used by the task.

By providing the task with a virtual reference clock that proceeds with clock cycles that are proportional to the ratio between the plurality of real-time clock cycles and real-time budget, the task's logic is less complicated. Now, a task only needs to know the time provided by the virtual clock and compare this time with the number of sub-processing steps that the task has already performed. This comparison is then a measure of performance for the task, because the progress of the reference time can be the notion of time the task experiences. The pluralities of clock cycles can denote a period of time wherein the task can perform an amount of work. Then, the real-time clock cycles can denote time that progresses since the beginning of the real-time period and the reference clock cycles can denote the reference time that progresses since the beginning of the reference-period. The start and end of both reference and real-time periods can be the same, but the progress of the different times can differ. The real-time time can progress with a normal clock frequency for the real-time processor, whereas the reference time progresses with the speed at which real-time budget is provided to the task. The progress of the reference time can be the notion of time the task experiences. The progress measurement or assessment can be used by tasks that work ahead, like for example video algorithms that process video frames or audio algorithms that decode audio streams.

An embodiment of the method according to the invention is described in claim 2. When a task knows whether it is ahead or behind with respect to the number of sub-processing steps it has performed and still must perform within the period of time, the task can react proactively to changing processing demands. When a task, for example a video algorithm is behind it can decide not to process the remainder of the frame because processing the remainder of the frame can cause a delay in processing a next frame. Alternatively, a task can decide to skip the next frame and finish processing the current frame within the next period. A task that can decide upon the processing quality, for example within approximation processing wherein the resolution of the pixels to be processed can vary, can decide to process at a lower quality when it is lagging behind or at a higher quality when it is ahead.

An embodiment of the method according to the invention is described in claim 3. By providing the real-time budget in a number of increments, other tasks that can run on the system can also use processor time. Then, the system can operate a number of tasks in parallel.

An embodiment of the method according to the invention is described in claim 4. By progressing the reference clock with the pace at which an increment of the plurality of increments is provided to the task, the task runs at a reference processor that has a clock that can run at a different frequency than the real-time processor.

An embodiment of the method according to the invention is described in claim 5. By not proceeding the reference clock when additional real-time budget is provided to the task, the task can still assess its progress with respect the number of sub-processing steps it has completed. The real-time budget is the budget it is guaranteed to receive during a predefined period. For example, when the task processes frames, the real-time budget can be the budget the task receives for each frame it has to process.

An embodiment of the method according to the invention is described in claim 6. By proceeding the reference clock when real-time budget is withdrawn to the task, the task can still assess its progress with respect to the number of sub-processing steps it has completed. When the real-time budget is withdrawn, the task has progressed to completion with respect to the reference clock.

An embodiment of the method according to the current invention is described in claim 7. By expressing the reference clock cycles in real-time clock cycles, tasks that can adapt their processing during a period, can determine more accurately whether they are ahead or behind and react correspondingly.

A further object of the invention is to provide a system according to the preamble that assesses the progress of a task in an improved way. To achieve this object, the system according to the invention is characterized in that the system further comprises:

reference clock means conceived to simulate a virtual reference clock that provides a plurality of reference clock cycles, wherein a reference clock cycle of the plurality of reference clock cycles is proportional to a ratio between the plurality of real-time clock cycles and the number of clock cycles comprised within the real-time budget;

proceeding means conceived to proceed the virtual reference clock at least one reference clock cycle when real-time budget is provided to the task;

wherein the administration means being further conceived to administrate a reference amount of the plurality of reference clock cycles.

Embodiments of the system for assessing progress of a task according to the invention are described in claims 9 and 10.

The invention will be described by means of embodiments illustrated by the following drawings:

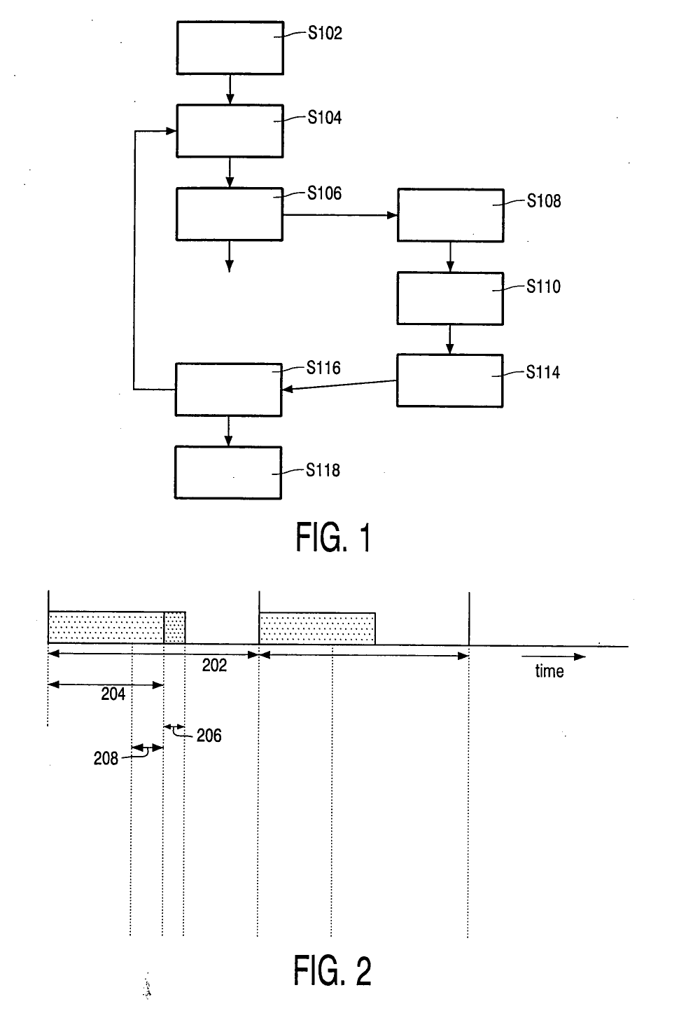

FIG. 1 illustrates the main steps of the method according to the invention;

FIG. 2 illustrates the notions of budget and periods;

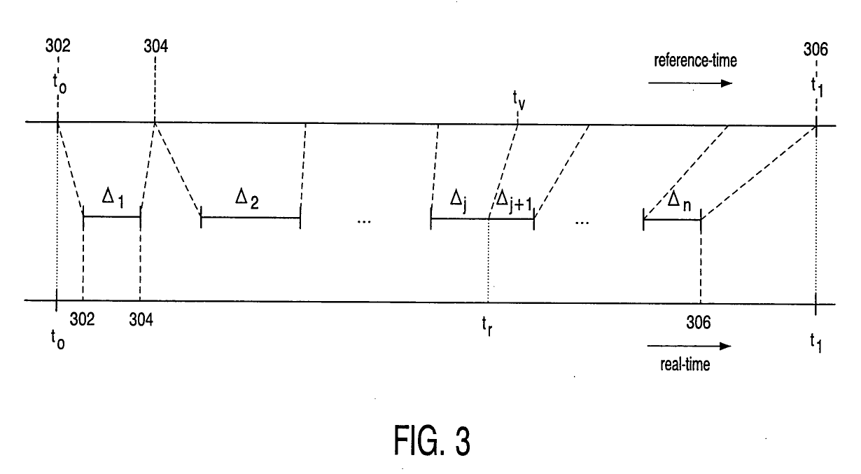

FIG. 3 illustrates the notions of real time and reference time;

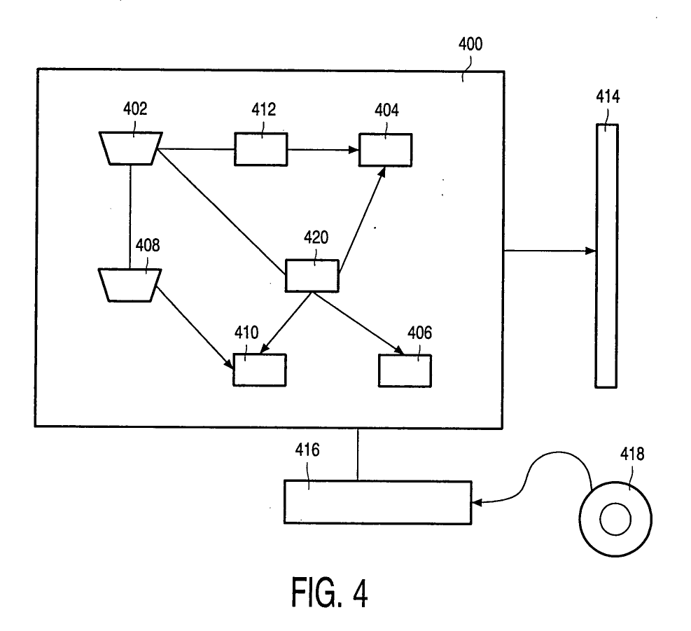

FIG. 4 illustrates the most important parts of an embodiment of the system according to the invention in a schematic way;

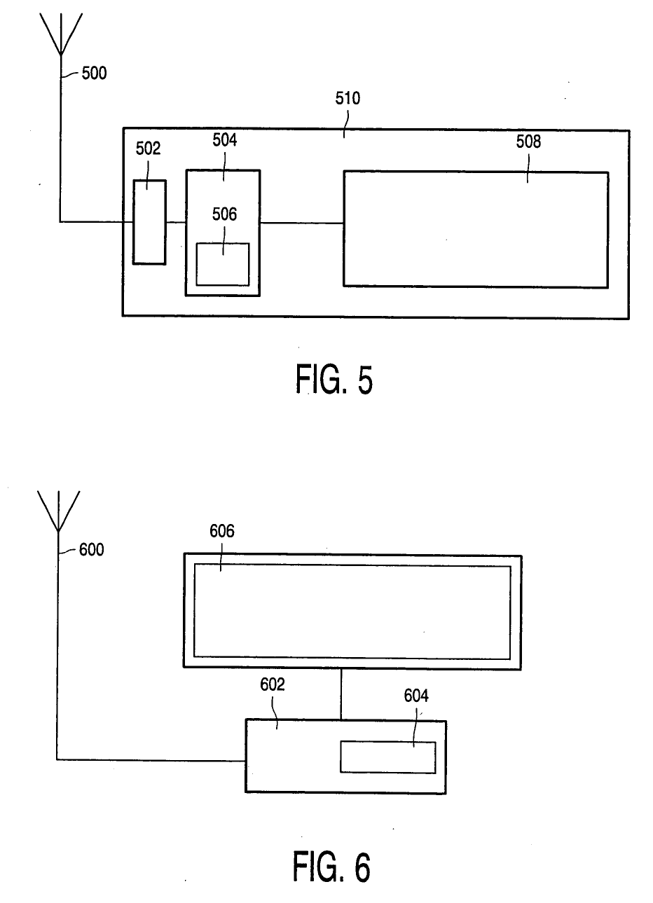

FIG. 5 illustrates a television set in a schematic way that comprises an embodiment of the system according to the invention;

FIG. 6 illustrates, in a schematic way, the most important parts of a set-top box that comprises an embodiment of the system according to the invention.

Nowadays, continuous media data processing is performed more and more by programmable components, rather than dedicated single-function components. One of the characteristics of continuous media data processing, such as is required for audio and video, is the presence of timing constraints also called deadlines. To handle such data appropriately, a system must observe the timing constraints and must guarantee sufficient system resources for processing. Since real time resources, such as a CPU and memory, are finite, sufficient system resources may not be reserved for a particular processing session. This can lead to tasks missing their deadlines, which can result into a degradation of the performance of the system and a less than optimal utilization of the available resources.

Continuous media data processing can be subdivided into tasks, wherein each task performs a processing step. For example, within an MPEG video decoder, decoding a video stream can be subdivided globally into the following tasks per frame that needs to be decoded: header detection, inverse Discrete Cosine Transformation, motion compensation and displaying a decoded frame. Each of these tasks on their turn can be subdivided into a number of sub-processing steps and each of these tasks can have a predefined number of periods during which it is allowed to run and process for example a video frame. Furthermore, all periods of a task can be of equal length and they can be consecutive. The budget of resources a task is allowed to consume during each of its periods is called a periodic budget. The periodic budgets of a task can be equal for each period or they can be different per period. Tasks can have deadlines indicating a time stamp before which a task must perform an amount of work, for example the detection of the header, within a period. Here, a deadline equals the end of a period. When a task does not meet its deadline within a period, it did not finish its processing step which influences the next processing steps negatively and can cause the overall performance of a system to degrade. Thus, tasks can perform an amount of work within a period wherein the period corresponds to for example the frame rate or tasks can perform an amount of work within a period wherein the period is independent from the frame rate and the budget is the same for each period. Especially when tasks work ahead, they can decide to adapt their processing depending upon their progress per unit to be processed.

FIG. 1 illustrates the main steps of an embodiment of the method according to the invention. The steps are performed additional to steps of methods performed by a commercially available real-time operating system called pSOS, together they are referred to as the system software The steps can also be performed additional to the steps of methods performed by other real-time operating systems such as VxWorks. The system software schedules the tasks and reserves the budgets of the real-time resources for the tasks. Consider a periodic task with a period of T, that is to be executed by a CPU or a co-processor that can also execute the task. Let's consider three situations:

1. a task consumes it's assigned budget completely

2. a task consumes additional time in addition to it's budget

3. a task consumes less time than its budget.

Below these three situations will be explained in more detail with reference to FIG. 1. Consider the first situation. Then within S102 the system software reserves a real-time budget of the clock cycles of the CPU, that the task is allowed to use during the current period. When the budget does not change for a number of consecutive periods this step can be performed only once for each time the budget has to change. This real-time budget expresses an amount of clock cycles of the CPU that the task can use for its processing, see FIG. 2. Within FIG. 2, 202 illustrates the period of the task, and 204 illustrates the real-time budget the task is allowed to use, or consume during the period. Every period 202, the system software guarantees that an amount of the real-time budget 204 is available to the task. The task optionally receives additional clock cycles 206, called slack time. This slack time is the time, or clock cycles, left over due to intrinsic scheduling imperfections or time left over by other tasks. Furthermore, a task can optionally receive less time, illustrated by 208, than its real-time budget 204. This is for example the case when the task is not allowed to run anymore during the period. Therefore, there can be considered three different notions of time:

real time: the time provided by the actual processor;

in-budget time: the real-time available to the task from its budget between two subsequent periods; and

consumed time: the amount of real-time consumed by a task which equals the in-budget time augmented with the consumed slack time and reduced with the produced slack time.

In order for a task to determine its progress easily without requiring special capabilities and interfaces for a task, a virtual reference clock is introduced and the task can refer to this virtual reference clock in stead of referring to the real-time processor. The virtual reference clock behaves to the task as the real-time clock, but it proceeds with a different frequency than the real-time processor. The number of clock cycleson this virtual reference clock is determined by the ratio between the plurality of real-time clock cycles comprised within the period 202 and the clock cycles comprised within the guaranteed budget of the task, see also FIG. 3. FIG. 3 illustrates the notions of real time tᵣ and reference time tᵥ. Here, the period 202 is illustrated as the time interval from t₀ to t₁. The system software guarantees the task for this time interval a predefined amount of real-time processor time, called the real-time budget 204. In the remainder of this section the real-time budget 204 is denoted by b₂₀₄ and the period 202 is denoted by T₂₀₂. This amount of real-time processor time is provided to the task in a number of increments Δⱼ, where 0<j ≦n and hence

$${b}_{204} = {\sum }_{k = 1}^{n} {Δ}_{n} .$$

Each time an increment is provided to the task, the virtual reference clock proceedsΔⱼ×T/B. Therefore, the virtual reference clock runs at a different frequency than the real-time processor. Besides reserving real-time resources for the task, the reference time on the reference clock is set equal to the real-time provided by the real-time processor within this step.

Within step S104 the task starts using its budget. The time the task starts using its budget is illustrated by 302, see FIG. 3. During the next step, step S106 the task consumes its budget and the task performes its subprocessing steps. The system software decides when the task can start using budget and when it must stop using its budget by resuming and suspending the task.

Within this step S106 the task can optionally perform the substep S108 of requesting the time from the system software, this time is illustrated by tᵥ. Then within S110 the system software will calculate the time on the reference clock tᵥ according to the following formula:

$${t}_{v} = {t}_{0} + ( {t}_{1} - {t}_{0} ) \times {\sum }_{k = 1}^{j} {Δ}_{k} / {b}_{204} .$$

The formula expresses that when the task receives its entire budget b₂₀₄ at the start of the interval, the reference time will be ahead of the real time: tᵥ>tᵣ. When the task receives its entire budget at the end of the interval, the reference time will be behind of the real time tᵥ<tᵣ. Stated in other words, the reference time may be ahead or behind during the period 202, depending on when the budget becomes available to the task. In any case, tᵥ=t₁ for j=n. Other formula's or ways to determine the time on the reference clock may be used too.

Within S112, the system software returns the virtual reference time to the task. Next, within an optional step S114 the task compares this time with the number of sub processing operations it has performed. When the number of processing operations is too small compared to the time the task already has consumed, the task is behind. For example: when a task consists of 100 operations and the reference time almost coincides with the end of the period, but the task has only performed 10 operations, the chance that the task will finish the left over 90 processing steps before the end of the period is very small.

An other way of assessing its process is by looking at the remaining time. Consider for example the situation that a task receives a worst case budget. This budget will only be used when extreme processing demands are requested or during an overload situation. During normal processing the task will normally not use its complete budget. Stated in other words, during normal execution the task will be finished processing while there is still remaining time upon the virtual reference clock. The amount of remaining time can then be used by the task to assess its progress. When the amount is larger than expected, the task is ahead, when it is less than expected the task is behind. For all situations the task can take appropriate measures by skipping work, refusing remaining budget or by performing the work with less effort when possible. Consider, for example a task that can improve the resolution of an image within a number of iterations, then, after each iteration it can decide not to increase the resolution when it is lagging behind. By skipping work, a task can catch up when it lags behind. Within an MPEG context, skipping work means skipping an entire B-frame or the last P-frame from a Group of Pictures (GOP) when no succeeding B-frame exists. When work is skipped, the next tasks that process the same work are influenced too

After deciding its progress, step S116 is performed. Step S116 can also be reached from S106, when the optional steps S108, S110, S112 and S114 are not performed. Within step S116, the task stops using its budget. The time the task stops using its budget is illustrated by 304, see FIG. 3. The steps from S104 to S116 are performed each time the task uses an increment of its budget. Upon completion the method reached S118.

Consider the second situation. After using the last increment, illustrated by 306, see FIG. 3 the time on the virtual reference clock will be equal to the real-time. Therefore, the system software will return this last reference clock time within S112 to the task, upon each request for the time after that the task has consumed its assigned budget.

Consider the third situation that occurs when the task does not consume an increment or returns its request for the resoure to the system software. Then within S116, the time on the reference clock is made equal to the real-time that denote the end of the period. The task is then finished for the current period.

Thus consumption and production of slack have no impact on the reference time.

The order in the described embodiment of the method of the current invention is not mandatory, a person skilled in the art may change the order of steps or perform steps concurrently using threading models, multi-processor systems or multiple processes without departing from the concept as intended by the current invention.

FIG. 4 illustrates the most important parts of an embodiment of the system according to the invention in a schematic way. The system 400 comprises a CPU 402. The system can also comprise more than one processor and co-processors. Furthermore, the system comprises the real-time system software within memory 412. Sub-system 420 comprises a task and memory 404 comprises the budget of real-time processor cycles that the task can use during its period as previously described. The content of memory 404 is determined by the real-time system software, which determines the budgets for all tasks that are operated by the system. The number of real-time processor cycles actually used by a task is administrated within memory 406. The system software has access to this memory. Memory 408 comprises the software that simulates the reference clock including its progress and memory 410 comprises the amount of reference clock cycles the reference clock proceeds during one period of a task. The reference clock proceeds with the speed as previously described when an increment of the real-time budget is provided to the task. The memory 410 is at least accessible by the task and the task can use its content to derive its progress. The system 400 is realized in software intended to be operated as an application run by a computer or any other standard architecture able to operate software. The system can be used to operate a digital television set 414. The software can also be updated from a storage device 418 that comprises a computer program product arranged to perform the method according to the invention. The storage device is read by a suitable reading device, for example a CD reader 416 that is connected to the system 400.

FIG. 5 illustrates a television set 510 in a schematic way that comprises an embodiment of the system according to the invention. Here an antenna, 500 receives a television signal. Any device able to receive or reproduce a television signal like, for example, a satellite dish, cable, storage device, internet, or Ethernet can also replace the antenna 500. A receiver, 502 receives the signal. The signal may be for example digital, analogue, RGB or YUV. Besides the receiver 502, the television set contains a programmable component, 504, for example a programmable integrated circuit. This programmable component contains a system according to the invention 506. A television screen 508 shows images that are received by the receiver 502 and are processed by the programmable component 504. When a user wants to record the received signal, for example a movie, the system according to the invention 506 records the received signal on the recording device like a DVD+RW, a compact disk or a harddisk. When a user wants to play a recorded movie, the system according to the invention 506 retrieves the appropriate data from the recording device.

FIG. 6 illustrates, in a schematic way, the most important parts of a set-top box that comprises an embodiment of the system according to the invention. Here, an antenna 600 receives a television signal. The antenna may also be for example a satellite dish, cable, storage device, internet, Ethernet or any other device able to receive a television signal. A set-top box 602, receives the signal. The signal may be for example digital, analogue, RGB or YUV. Besides the usual parts that are contained in a set-top box, but are not shown here, the set-top box contains a system according to the invention 604. When a user wants to record the received signal, for example a movie, the system according to the invention 604 records the received signal on the recording device like a DVD+RW, a compact disk or a harddisk. When a user wants to play a recorded movie, the system according to the invention 604 retrieves the appropriate data from the recording device. The television set 606 can show the output signal generated from a received signal by the set-top box 602.

1. A method of assessing progress of a task, the task executing on a real-time processor, the real-time processor providing a plurality of real-time clock cycles and the method comprising the following steps:
a first step of reserving a real-time budget for the task, wherein the real-time budget comprises a number of clock cycles that is equal to at least a part of the plurality of real-time clock cycles;
a second step of assessing the progress of the task by administrating a real amount of the plurality of real-time clock cycles used by the task characterized in that
the task further refers to a virtual reference clock, the virtual reference clock providing a plurality of reference clock cycles, wherein a reference clock cycle of the plurality of reference clock cycles is proportional to a ratio between the plurality of real-time clock cycles and the number of clock cycles comprised within the real-time budget; and the method further comprises:
a third step of proceeding the virtual reference clock at least one reference clock cycle when real-time budget is provided to the task; and
wherein the second step of the method further comprises administrating a reference amount of the plurality of reference clock cycles used by the task.

2. A method of assessing progress of a task according to claim 1, wherein the progress of the task is ahead when a reference time represented by reference amount exceeds the real amount and the progress of the task is behind when the reference time represented by the reference amount is smaller than the real amount.

3. A method of assessing progress of a task according to claim 1, wherein the real-time budget is provided to the task in a plurality of increments.

4. A method of assessing progress of a task according to claim 3, wherein the reference clock proceeds when an increment of the plurality of increments is provided to the task.

5. A method of assessing progress of a task according to claim 1, wherein the reference clock does not proceed when additional real-time budget is provided to the task.

6. A method of assessing progress of a task according to claim 1, wherein the reference clock does proceed when the real-time budget is withdrawn from the task.

7. A method of assessing progress of a task according to claim 4, wherein a clock cycle tᵣ of the plurality of reference clock cycles is expressed in the plurality of real-time clock cycles:
$${t}_{r} = {t}_{0} + ( {t}_{1} - {t}_{0} ) \times {\sum }_{k = 1}^{j} \frac{{Δ}_{k}}{{b}_{sys}}$$
wherein b_{sys} is the real-time budget, Δₖ is an increment of the plurality of increments, t₀ is a first clock cycle of the plurality of reference clock cycles, and t₁ is an end of the plurality of real-time clock cycles.

8. A system (400) for assessing progress of a task, the system comprising:
real-time processor means (402) conceived to provide a plurality of real-time clock cycles;
reserving means (404) conceived to reserve a real-time budget for the task, wherein the real-time budget comprises a number of clock cycles that is equal to at least a part of the plurality of real-time clock cycles;
administration means (406) conceived to administrate a real amount of the plurality of real-time clock cycles used by the task to assess the progress of the task characterized in that the system further comprises:
reference clock means (408) conceived to simulate a virtual reference clock that provides a plurality of reference clock cycles, wherein a reference clock cycle of the plurality of reference clock cycles is proportional to a ratio between the plurality of real-time clock cycles and the number of clock cycles comprised within the real-time budget;
proceeding means (408) conceived to proceed the virtual reference clock at least one reference clock cycle when real-time budget is provided to the task;
wherein the administration means (410) being further conceived to administrate a reference amount of the plurality of reference clock cycles.

9. A system (400) according to claim 8, wherein the proceeding means (408) is further conceived to proceed the virtual reference clock at least one clock cycle when an increment of a plurality of increments of the real-time budget is provided to the task.

10. A computer program product arranged to perform the method according to any of the claims 1 to 7.

11. A storage device (418) comprising a computer program product according to claim 10.

12. A television set (510) comprising a receiver (502) for receiving a video signal, a programmable component (504) for running a task processing the video signal, a display screen (508) for displaying the processed video signal and a system according to claim 8 or 9.

13. A set-top box (602) comprising a receiver (602) for receiving a video and/or audio stream and decoding the video and/or audio stream, and a system according to claim 8 or 9.
